(19) United States
(12) Patent Application Publication
(10) Pub. No.: US 2009/0102927 A1
(43) Pub. Date: Apr. 23, 2009

(54) WIRELESS TRANSMISSION SYSTEM FOR REGISTERING SOURCE DEVICE IN SINK DEVICE

(76) Inventors: Akihiro Tatsuta, Kyoto (JP); Makoto Funabiki, Osaka (JP); Hiroshi Ohue, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/279,009

(22) PCT Filed: Feb. 8, 2007
(86) PCT No.: PCT/JP2007/052263

§ 371 Date: Dec. 16, 2008

(30) Foreign Application Priority Data
Feb. 10, 2006 (JP) 2006-033538

(51) Int. Cl. H04N 17/00; H04N 5/38

(52) U.S. Cl. 348/192; 348/723; 348/E17.001; 348/E05.093

(57) ABSTRACT

A wireless communication system is disclosed, which includes a source device having a high-rate wireless transmitter circuit for wirelessly transmitting a video signal, and a sink device having a high-rate wireless receiver circuit for receiving the wirelessly transmitted video signal. The source device includes a memory for storing a device ID of the source device and a low-rate wireless transceiver circuit, in addition to the high-rate wireless transmitter circuit. The low-rate wireless transceiver circuit wirelessly transmits a control signal including the device ID read-out from the memory to the sink device, and wirelessly receives a registration control signal for registering the source device in the sink device, from the sink device.

### TECHNICAL FIELD

The present invention relates to a source device such as a DVD player or a set-top box, a sink device such as a television receiver, a wireless communication system wirelessly transmitting a video signal and the like reproduced and outputted by the source device to the sink device as an uncompressed signal, and a method of registering the source device in the sink device.

### BACKGROUND ART

The audiovisual equipments adopting an HDMI (High Definition Multimedia Interface) have been in widespread use in the market. In this case, the HDMI is an interface standard for next-generation digital televisions for transmitting an uncompressed video signal and an uncompressed audio signal via one cable. Conventionally, it has been required to use different cables for respective signals such as a video signal and an audio signal, in order to connect a plurality of audiovisual equipments to each other. However, the HDMI has such an advantage that the interconnection between the audiovisual equipments can be simplified as compared before. In addition, since data are transmitted digitally in the HDMI, there is such an advantage that data transmission with large noise resistance and high image quality can be provided. In addition, since a control signal can be transmitted bi-directionally, the HDMI is advantageous in such a case that a television set and a DVD player are controlled to cooperate with each other, or in such a case that a home theater is constructed by a surround loudspeaker and a large-screen display and an entire system of the home theater is controlled. In the HDMI, since high quality contents can be transmitted, an HDCP (High-bandwidth Digital Content Protection System) is used as a content protection method for preventing illegal use and illegal copying of provided contents. In the HDCP, there are defined device authentications at a transmitter side and a receiver side, a key sharing system for the authentications, and an encrypting method for the contents to be transmitted.

Patent Document 1 discloses a content communication system according to a prior art, which performs registration and authentication of a counterpart device safely and securely, when content signals are wirelessly communicating. In the content communication system according to the prior art, an interface of a communication device for connecting a content signal output device thereto is connected to an interface of a communication device for connecting a content providing device thereto, via wired communication, and the communication devices exchange identification information and key information with each other. Thereafter, the content communication system transmits the content signal provided from the interface, as a wireless signal via an antenna. When the content signal received via an antenna is supplied from the interface to the content providing device, the content communication system exchanges the exchanged identification information between the communication devices as a second wireless signal, and compares the exchanged identification information with registered identification information to perform authentication.

Patent Document 1: Japanese patent laid-open publication No. JP-2005-528853-A.

Non-Patent Document 1: High-Definition Multimedia Interface Specification, Version 1.1, HDMI Licensing, LLC, California in U.S.A., May 20, 2004.

### DISCLOSURE OF THE INVENTION

### Problems to be Solved by the Invention

However, the content communication system according to the prior art has such a problem that a user is forced to perform an operation for connecting the communication devices to each other via the wired communication, at the time of an initial setting for registration. In particular, when a plurality of communication devices are used, the user needs more labor and longer time. In addition, there is such a problem that, when the communication devise is built into a source device or a sink device, although the source device or the sink device is configured to build the communication device therein, the source device or the sink device needs an external interface for the wired connection, and this leads to an increased costs.

It is an object of the present invention to provide a source device, a sink device, a wireless communication system, and a registration method therefor, each capable of solving the above-stated problems, lessening user's burden at the time of an initial setting for registration of the source device in the sink device, and ensuring high confidentiality, in the wireless communication system for wirelessly transmitting a video signal between the source device and the sink device.

### Means for Solving the Problems

A source device according to the first invention is a source device for use in a wireless communication system including the source device and a sink device. In this case, the source device includes wireless transmitter means for wirelessly transmitting a video signal, and the sink device includes wireless receiver means for receiving the wirelessly transmitted video signal. The source device is characterized by including first storage means for storing identification information on the source device, and first wireless transceiver means for wirelessly transmitting a control signal including the identification information read-out from the first storage means to the sink device, and for wirelessly receiving a registration control signal for registering the source device in the sink device, from the sink device.

The above-mentioned source device is characterized by, upon registering the source device in the sink device, the wireless transmitter means wirelessly transmitting a predetermined test pattern signal to the sink device, and the first wireless transceiver means wirelessly transmitting the control signal including the read-out identification information to the sink device. In this case, the test pattern signal may include a predetermined test video signal.

In addition, the above-mentioned source device is characterized by, upon registering the source device in the sink device, the wireless transmitter means wirelessly transmitting a plurality of predetermined test pattern signals to the sink device at transmission rates different from each other, respectively, and the first wireless transceiver means wirelessly transmitting the control signal including the read-out identification information to the sink device. In this case, the test pattern signals may include predetermined test video signals, respectively.

Further, the above-mentioned source device is characterized by further including first display means, first input means, and first controller means. In this case, the first controller means displays on the first display means a request to select whether or not to register the source device in the sink device. When it is selected to register the source device in the sink device using the first input means, the first controller means controls the first wireless transceiver means to wirelessly transmit the control signal including the read-out identification information to the sink device.

Still further, the above-mentioned source device is characterized by the wireless transmitter means including a directional antenna, and the first wireless transceiver means including an omni-directional antenna.

In addition, the above-mentioned source device is characterized by a transmission rate of the wireless transmitter means for wireless transmission being larger than that of the first wireless transceiver means for wireless transmission and receiving.

A sink device according to the second invention is a sink device for use in a wireless communication system including a sour device and the sink device. In this case, the source device includes wireless transmitter means for wirelessly transmitting a video signal, and the sink device includes wireless receiver means for receiving the wirelessly transmitted video signal. The sink device is characterized by including second wireless transceiver means, second storage means, second display means, and second controller means. The second wireless transceiver means wirelessly receives a control signal including identification information on the source device from the source device, and wirelessly transmits a registration control signal for registering the source device in the sink device to the source device. The second storage means stores and registers the wirelessly received identification information. The second display means displays the video signal from the source device. The second controller means controls the second display means to display the video signal from the source device thereon, when the wireless receiver means wirelessly receives the video signal from the source device, and only when identification information corresponding to the source device is registered in the second storage means.

The above-mentioned source device is characterized by, upon registering the source device in the sink device, the wireless receiver means wirelessly receiving a predetermined test pattern signal from the source device, and the second wireless transceiver means wirelessly receiving the control signal including the identification information from the source device. In addition, the second controller means measures a value indicating a receiving status of the test pattern signal, and controls the second storage means to store and register the wirelessly received identification information therein when the value indicates a receiving status better than a receiving status indicated by a predetermined threshold value.

In addition, the above-mentioned source device is characterized by, upon registering the source device in the sink device, the wireless receiver means wirelessly receiving a test pattern signal including a predetermined test video signal, and the second wireless transceiver means wirelessly receiving the control signal including the identification information from the source device. In addition, the second controller means displays on the second display means the test video signal and a request to select whether or not to register the source device in the sink device, and controls the second storage means to store and register the wirelessly received identification information therein when it is selected to register the source device in the sink device using the second input means.

Further, the above-mentioned source device is characterized by the wireless receiver means wirelessly receiving a plurality of predetermined test pattern signals wirelessly transmitted at transmission rates different from each other, respectively, from the source device, and the second wireless transceiver means wirelessly receiving the control signal including the identification information from the source device. In addition, the second controller means measures values indicating receiving statuses of the plurality of test pattern signals, respectively, and controls the second storage means to store and register a transmission rate corresponding to a test pattern signal having a best value, and the wirelessly received identification information therein, so that the transmission rate corresponding to the test pattern signal having the best value corresponds to the wirelessly received identification information.

Still further, the above-mentioned source device is characterized by the wireless receiver means wirelessly receiving a plurality of test pattern signals including predetermined test video signals and wirelessly transmitted at transmission rates different from each other, respectively, and the second wireless transceiver means wirelessly receiving the control signal including the identification information from the source device. In addition, the second controller means displays on the second display means (a) the test video signals for the respective transmission rates different from each other and (b) a request to select whether or not to register the source device in the sink device, and controls the second storage means to store and register the wirelessly received identification information therein when it is selected to register the source device in the sink device using the second input means.

In addition, the above-mentioned source device is characterized by the second wireless transceiver means wirelessly receiving the control signal including the identification information from the source device. In addition, the second controller means displays on the second display means a request to select whether or not to register the source device in the sink device, and controls the second storage means to store and register the wirelessly received identification information therein when it is selected to register the source device in the sink device using the second input means.

Further, the above-mentioned source device is characterized by the wireless receiver means including a directional antenna, and the second wireless transceiver means including an omni-directional antenna.

Still further, the above-mentioned source device is characterized by a transmission rate of the wireless receiver means for wireless receiving being larger than that of the second wireless transceiver means for wireless transmission and receiving.

A wireless communication system according to the third invention is characterized by including the above-mentioned source device and the above-mentioned sink device.

A method of registering as used in a wireless communication system of the forth invention is a method of registering a source device in a sink device as used in the wireless communication system including the source device and the sink device. In this case, the source device includes wireless transmitter means for wirelessly transmitting a video signal, and the sink device includes wireless receiver means for receiving the wirelessly transmitted video signal. The source device includes first storage means for storing identification information on the source device, and the sink device includes second storage means for storing and registering the identification information, and second display means for displaying the video signal from the source device. The method is characterized by including the steps of: at the sink device, wirelessly transmitting a registration control signal for registering the source device in the sink device to the source device; at the source device, wirelessly receiving the registration control signal from the sink device; at the source device, wirelessly transmitting a control signal including the identification information read-out from the first storage means to the sink device; at the sink device, wirelessly receiving the control signal including the identification information from the source device, and storing and registering the identification information in the second storage means; and at the sink device, displaying the video signal from the source device on the second display means, when the sink device wirelessly receives the video signal from the source device, and only when identification information corresponding to the source device is registered in the second storage means.

### EFFECTS OF THE INVENTION

Accordingly, according to the source device, the sink device, the wireless communication system, and the registration method therefor according to the present invention, the source device wirelessly transmits the control signal including the identification information on the source device to the sink device, and the sink device wirelessly receives and registers the control signal including the identification information on the source device and registers the identification information. In addition, when the sink device wirelessly receives a video signal from the source device, the sink device displays the video signal from the source device, only when identification information corresponding to the source device is registered in the sink device. Accordingly, in the wireless communication system for wirelessly transmitting the video signal between the source device and the sink device, it is possible to lessen user's burden at the time of the initial setting for the registration of the source device in the sink device, and to ensure excellent confidentiality.

In addition, upon registering the source device in the sink device, the source device wirelessly transmits a predetermined test pattern signal to the sink device, the sink device wirelessly receives the test pattern signal, and the sink device measures a value indicating the receiving status of the test pattern signal. When the value indicates a receiving status better than a receiving status indicated by a predetermined threshold value, the sink device registers the identification information on the source device. Accordingly, it is possible to further lessen the user's burden at the time of the initial setting.

In addition, upon registering the source device in the sink device, the source device wirelessly transmits a test pattern signal including a predetermined test video signal to the sink device, the sink device wirelessly receives the test pattern signal, and the sink device displays the test video signal and a request to select whether or not to register the source device in the sink device. Further, the sink device registers the wirelessly received identification information, when it is selected to register the source device in the sink device. Accordingly, the sink device can receive and output a high quality video signal and a high quality audio signal.

Further, upon registering the source device in the sink device, the source device wirelessly transmits a plurality of predetermined test pattern signals to the sink device at transmission rates different from each other, respectively. In addition, the sink device measures values indicating receiving statuses of the plurality of test pattern signals, respectively, and registers a transmission rate corresponding to a test pattern signal having a best value and the identification information on the source device, so that the transmission rate corresponding to the test pattern signal having the best value corresponds to the wirelessly received identification information. Accordingly, it is possible to further lessen the user's burden at the time of the initial setting, and the sink device can receive and output a high quality video signal and a high quality audio signal.

Still further, upon registering the source device in the sink device, the source device wirelessly transmits a plurality of predetermined test pattern signals including predetermined test video signals to the sink device at transmission rates different from each other, respectively, the sink device displays the test video signals included in the test pattern signals wirelessly transmitted at the respective transmission rates different from each other and a request to select whether or not to register the source device in the sink device. In addition, the sink device registers the identification information on the source device, when it is selected to register the source device in the sink device. Accordingly, the sink device can receive and output a high quality video signal and a high quality audio signal.

In addition, the sink device wirelessly receives the control signal including the identification information from the source device, and displays a request to select whether or not to register the source device in the sink device. Further, the sink device registers the identification information on the source device when it is selected to register the source device in the sink device. Accordingly, it is possible to shorten time required for a registration process and to simplify the initial setting.

Further, the source device displays a request to select whether or not to register the source device in the sink device, and wirelessly transmits the control signal including the identification information on the source device, when it is selected to register the source device in the sink device. Accordingly, it is possible for the source device to display and input whether or not to register the source device in the sink device.

### BRIEF DESCRIPTION OF THE DRAWINGS

FIG. 1 is a block diagram showing a configuration of a wireless communication system according to a first embodiment of the present invention.

FIG. 2 is a perspective view showing an implementation example of antennas provided on an IC chip including a source device 1 of FIG. 1.

FIG. 3 is a sequence diagram showing a registration process performed by the wireless communication system of FIG. 1.

FIG. 4 is a sequence diagram showing a registration process performed by a wireless communication system according to a second embodiment of the present invention.

FIG. 5 is a sequence diagram showing a registration process performed by a wireless communication system according to a third embodiment of the present invention.

FIG. 6 is a sequence diagram showing a registration process performed by a wireless communication system according to a fourth embodiment of the present invention.

FIG. 7 is a sequence diagram showing a registration process performed by a wireless communication system according to a fifth embodiment of the present invention.

FIG. 8 is a block diagram showing a configuration of a wireless communication system according to a sixth embodiment of the present invention.

FIG. 9 is a sequence diagram showing a registration process performed by a wireless communication system of FIG. 8.

### DESCRIPTION OF REFERENCE SYMBOLS

1 and 1A . . . Source device,
2. . . . Sink device,
3A and 4A . . . . Omni-directional antenna,
3B and 4B . . . . Directional antenna,
10 and 20 . . . . Controller,
11 and 21 . . . . Memory,
12 . . . DVD player,
13. . . . High-rate wireless transmitter circuit,
14 and 26 . . . . Antenna selector and beam former circuit,
15 and 27 . . . . Low-rate wireless transceiver circuit,
16 and 28 . . . . Antenna selector circuit,
22 and 40 . . . . Display,
23. . . . Loudspeaker,
24 and 41 . . . . Keyboard,
25. . . . High-rate wireless receiver circuit,
29. . . . Audio signal and video signal processing circuit.

### BEST MODE FOR CARRYING OUT THE INVENTION

Embodiments of the present invention will be described hereinafter with reference to the drawings. In the embodiments, components similar to each other are denoted by the same reference numerals.

### First Embodiment

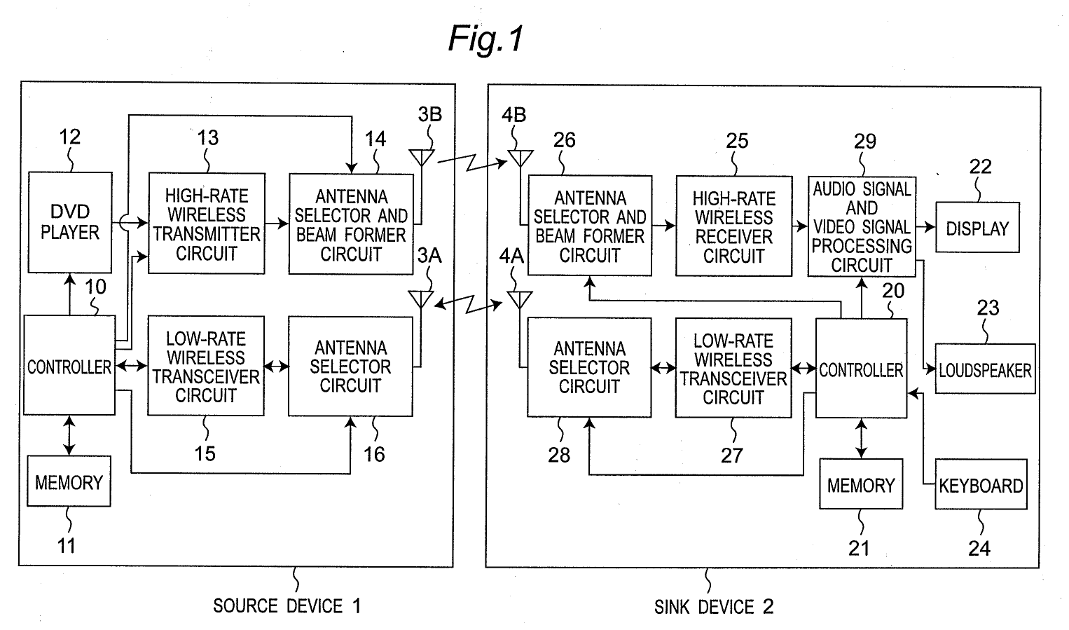

FIG. 1 is a block diagram showing a configuration of a wireless communication system according to a first embodiment of the present invention. In the present embodiment, the wireless communication system includes a source device 1 and a sink device 2. The source device 1 and the sink device 2 transmit various signals based on the HDMI (High Definition Multimedia Interface) standard. Referring to FIG. 1, the source device 1 is configured to include a controller 10, a memory 11, a DVD player 12, a high-rate wireless transmitter circuit 13, an antenna selector and beam former circuit 14, a low-rate wireless transceiver circuit 15, an antenna selector circuit 16, a directional antenna 3B, and an omni-directional antenna 3A.

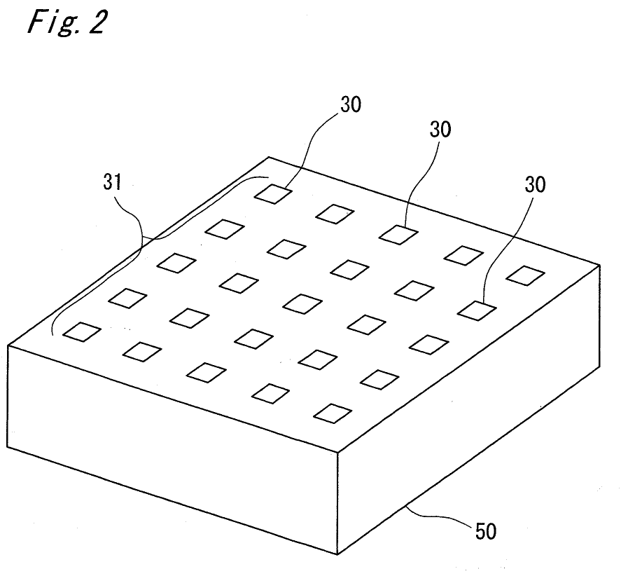

Referring to FIG. 1, the DVD player 12 reads out a video signal and an audio signal recorded in a recording medium such as a DVD, and outputs the video signal and the audio signal to the high-rate wireless transmitter circuit 13 under control of the controller 10. For example, the memory 11 includes a ROM (Read Only Memory), a RAM (Random Access Memory) and the like. In this case, the memory 11 stores a test pattern signal including a test video signal and a test audio signal, and identification information unique to the source device 1, such as a device ID or a MAC address in the ROM. In addition, the memory stores the other data and the like in the RAM. The high-rate wireless transmitter circuit 13 encodes the video signal and the audio signal read-out by the DVD player 12 or the test pattern signal read-out from the memory 11 via the controller 10, and generates transmitting packets. Then, the high-rate wireless transmitter circuit 13 modulates a carrier wave having a high frequency of, e.g., about 60 GHz fallen within a millimeter waveband, according to the generated transmitting packets, to generate an AV wireless signal including a video signal and a audio signal of uncompressed signals, and outputs the generated AV wireless signal to the antenna selector and beam former circuit 14. Generally speaking, in the wireless communication system, when a carrier wave frequency is higher, a transmission rate can be set to be larger, and a transmission rate of the high-rate wireless transmitter circuit 13 is set to be larger than that of the low-rate wireless transceiver circuit 15 which will be described later. Under control of the controller 10, the antenna selector and beam former circuit 14 selects a part of a plurality of antenna elements constituting the directional antenna 3B from an array antenna device 31 of FIG. 2 to form a beam having a predetermined direction, and transmits the AV wireless signal outputted from the high-rate wireless transmitter circuit 13 to the sink device 2 via the directional antenna 3B.

In order to make it possible for the video signal and the audio signal read-out by the source device 1 to be viewed and listened to, respectively, by using the sink device 2, the controller 10 transmit and receive control signals (including registration control signals including a timing signal, a registration request signal, registration control signals, registration request notification signal and a registration completion signal, and a device information signal) for registering the source device 1 in the sink device 2, between the source device 1 and the sink device 2, to perform a registration process (to be described later in detail). The low-rate wireless transceiver circuit 15 performs an encoding process on the control signals to be transmitted to the sink device 2, and generates transmitting packets. Then the low-rate wireless transceiver circuit 15 modulates a carrier wave having a frequency fallen within a band such as the millimeter waveband, according to the generated transmitting packets to generate control wireless signals, and transmits the control wireless signals to the sink device 2 from the antenna 3A via the antenna selector circuit 16. Further, the low-rate wireless transceiver circuit 15 receives control wireless signals having a predetermined frequency from the sink device 2 via the omni-directional antenna 3A and the antenna selector circuit 16, performs a frequency conversion process, a received packet process, and a decoding process on the control wireless signals, and outputs the processed control signals to the controller 10. Under control of the controller 10, the antenna selector circuit 16 selects at least one antenna element constituting the omni-directional antenna 3A from the array antenna device 31 of FIG. 2, and transmits and receives the control wireless signals including the control signals to and from the sink device 2 via the omni-directional antenna 3A.

In this case, FIG. 2 is a perspective view showing an implementation example of the omni-directional antenna 3A and the directional antenna 3B provided on an IC chip 50 including the source device 1 of FIG. 1. Referring to FIG. 2, there is provided the array antenna device 31 configured to include, for example, twenty-five rectangular patch antenna elements 30 placed in five rows and five columns on the IC chip 50. The omni-directional antenna 3A is configured to include at least one (e.g., three) predetermined antenna element 30 selected from among all of the antenna elements 30 by the antenna selector circuit 16. The directional antenna 3B is configured to include a plurality of (e.g., five) predetermined antenna elements 30 selected from among all of the antenna elements 30 by the antenna selector and beam former circuit 14. During the receiving, wireless signals received by the respective selected antenna elements 30 are weighted by the antenna selector and beam former circuit 14, respectively, so as to form a beam having a desired directivity. During the transmission, respective signals from the high-rate wireless transmitter circuit 13 are weighted, respectively, by the antenna selector and beam former circuit 14 based on weight factors or a beam direction (or an instructed beam direction) determined during the receiving, so that the directional antenna 3B has the beam direction. The omni-directional antenna 3A and the directional antenna 3B are shown separately in FIG. 1 for clarifications of the descriptions in FIG. 1, however, the same antenna elements can be shared between the omni-directional antenna 3A and the directional antenna 3B as shown in FIG. 2.

Referring back to FIG. 1, the sink device 2 is configured to include a controller 20, a memory 21, a display 22, a loudspeaker 23, a keyboard 24, a high-rate wireless receiver circuit 25, an antenna selector and beam former circuit 26, a low-rate wireless transceiver circuit 27, an antenna selector circuit 28, an audio signal and video signal processing circuit, a directional antenna 4B, and an omni-directional antenna 4A. In a manner similar to that of the antenna selector and beam former circuit 14, the antenna selector and beam former circuit 26 selects a plurality of antenna elements constituting the directional antenna 4B from the array antenna device 31 of FIG. 2 to generate a beam having a predetermined direction, and receives and outputs the AV wireless signal transmitted from the source device 1, under control of the controller 20. The high-rate wireless receiver circuit 25 performs a frequency conversion process, a received packet process, and a decoding process on the AV wireless signal outputted from the antenna selector and beam former circuit 26, and thereafter, outputs the processed AV signal including the video signal and the audio signal to the audio signal and video signal processing circuit 29. A transmission rate of the high-rate wireless receiver circuit 25 is set to be equal to that of the high-rate wireless receiver circuit 13. Under control of the controller 20, the audio signal and video signal processing circuit 29 separates the processed AV signal outputted from the high-rate wireless receiver circuit 25 into the video signal and the audio signal, outputs the video signal to the display 22 to display the video signal thereon, and outputs the audio signal to the loudspeaker 23.

In addition, under control of the controller 20, the antenna selector circuit 28 selects at least one antenna element constituting the omni-directional antenna 4A from the array antenna device 31 of FIG. 2, and transmits and receives the control wireless signal including the control signals to and from the source device 1 via the omni-directional antenna 4A. The low-rate wireless transceiver circuit 27 encodes the control signals to be transmitted to the source device 1, and generates transmitting packets. Then, the low-rate wireless transceiver circuit 27 modulates a carrier wave having a frequency fallen within a band such as the millimeter waveband, according to the generated transmitting packets to generate control wireless signals, and transmits the control wireless signals, to the source device 1 from the omni-directional antenna 4A via the antenna selector circuit 28. Further, the low-rate wireless transceiver circuit 27 receives the control wireless signals having a predetermined frequency via the omni-directional antenna 4A and the antenna selector circuit 28, performs a frequency conversion process, a received packet process, and a decoding process on the control wireless signals, and transmits the processed control signals to the controller 20. A transmission rate of the low-rate wireless transceiver circuit 27 is set to be equal to that of the low-rate wireless transceiver circuit 15. The controller 20 transmits and receives the control signals for registering the source device 1 in the sink device 2, between the source device 1 and the sink device 2, to perform a registration process (to be described later in detail). Further, when there is an input signal from the keyboard 24, the controller 20 stores and registers the device ID of the source device 1 in the memory 21 including, for example, a RAM, based on the input signal. Since the omni-directional antenna 4A and the directional antenna 4B are configured in manners similar to those of the omni-directional antenna 3A and the directional antenna 3B described with reference to FIG. 2, respectively, the omni-directional antenna 4A and the directional antenna 4B will not be described in detail.

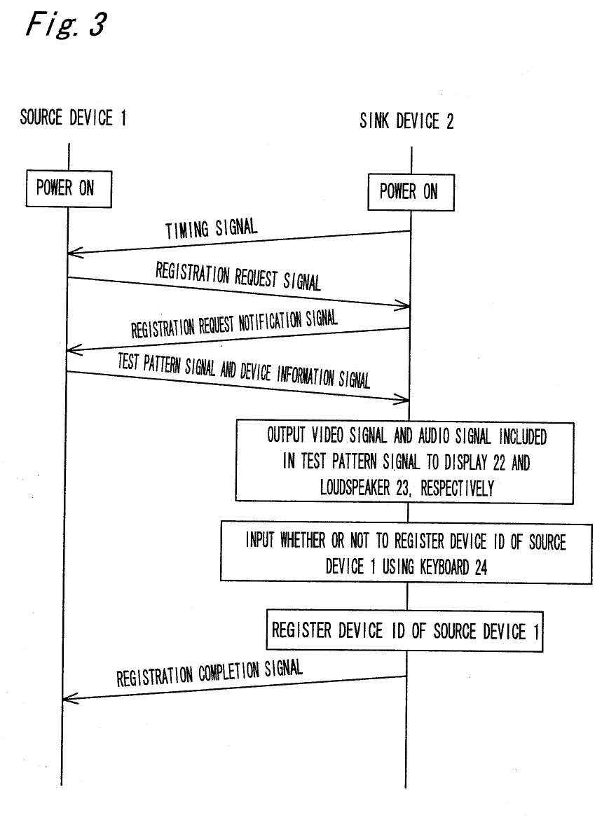

FIG. 3 is a sequence diagram showing the registration process performed by the wireless communication system according to the present embodiment. For content protection, first of all, it is required to perform an initial setting for registering the source device 1 in the sink device 2 using the device ID unique to the source device 1, and to make it possible for only the video signal and the audio signal transmitted by the registered source device 1 to be viewed and listened to, respectively, using the sink device 2.

Referring to FIG. 3, first of all, when the power of the sink device 2 is turned on, the sink device 2 transmits a timing signal to the source device 1 via the omni-directional antenna 4A periodically. When the power of the source device 1 is turned on, the source device 1 receives the timing signal transmitted from the sink device 2 via the omni-directional antenna 3A. In response to this timing signal, the source device 1 transmits the registration request signal for registering the source device 1 in the sink device 2 via the omni-directional antenna 3A.

In response to the registration request signal, the sink device 2 transmits the registration request notification signal indicating receiving of the registration request signal to the source device 1 via the omni-directional antenna 4A. In response to the registration request notification signal, the source device 1 transmits a test pattern signal to the sink device 2 via the directional antenna 3B, and transmits the device information signal including the device ID of the source device 1 to the sink device 2 via the omni-directional antenna 3A.

Upon receiving the test pattern signal via the directional antenna 4B, the sink device 2 outputs the test video signal and the test audio signal included in the test pattern signal to the display 22 and the loudspeaker 23, respectively. The sink device 2 displays a message or the like requesting a user to select whether or not to register the device ID of the source device 1 on the display 22. The user views and listening to an image and a voice outputted to the display 22 and the loudspeaker 23, respectively, to determine a receiving status, and selects whether or not to register the source device 1 in the sink device 2 using the keyboard 24. When the user selects registration of the source device 1 in the sink device 2, the sink device 2 stores and registers the device ID of the source device 1 in the memory 21 of the sink device 2. On the other hand, when the user does not select the registration, the source device 2 completes the process.

After storing and registering the device ID of the source device 1 in the memory 21 of the sink device 2, the sink device 2 transmits the registration completion signal indicating completion of the registration of the source device 1 in the sink device 2 to the source device 1 via the omni-directional antenna 4A.

As described above, in the wireless communication system according to the present embodiment, the source device 1 Tirelessly transmits the control signal including the device ID of the source device 1 to the sink device 2, and the sink device 2 wirelessly receives and registers the control signal including the device ID of the source device 1. When the sink device 2 wirelessly receives the video signal from the source device 1, the sink device 2 displays the video signal from the source device 1, only when the device ID corresponding to the source device 1 is registered in the sink device 2. Accordingly, there is no need to connect the source device 1 and the sink device 2 via the wired connection, at the time of the initial setting for registering the source device 1 in the sink device 2. Therefore, it is possible to lessen the user's burden during the initial setting. In addition, only the source device 1 having specific positional relationship with the sink device can be registered in the sink device 2, in which the antennas 3A and 3B of the source device 1 can hold wireless communication with the antennas 4A and 4B of the sink device 2, respectively. Accordingly, it is possible to ensure excellent confidentiality.

In addition, upon registering the source device 1 in the sink device 2, the source device 1 wirelessly transmits the test pattern signal to the sink device 2, and the sink device 2 wirelessly receives the test pattern signal and displays the test video signal and a request to select whether or not to register the source device 1 in the sink device 2. Further, the sink device 2 registers the Tirelessly received identification information, when it is selected to register the source device 1 in the sink device 2. Accordingly, the sink device 2 can receive and output a high quality video signal and a high quality audio signal.

In the present embodiment, the source device 1 wirelessly transmits the video signal and the audio signal read-out from the recording medium such as the DVD to the sink device 2. However, the present invention is not limited to this operation. When the recording medium includes digital data other than the video signal and the audio signal as content, the digital date may be wirelessly transmitted and viewed and listened to at the sink device 2.

### Second Embodiment

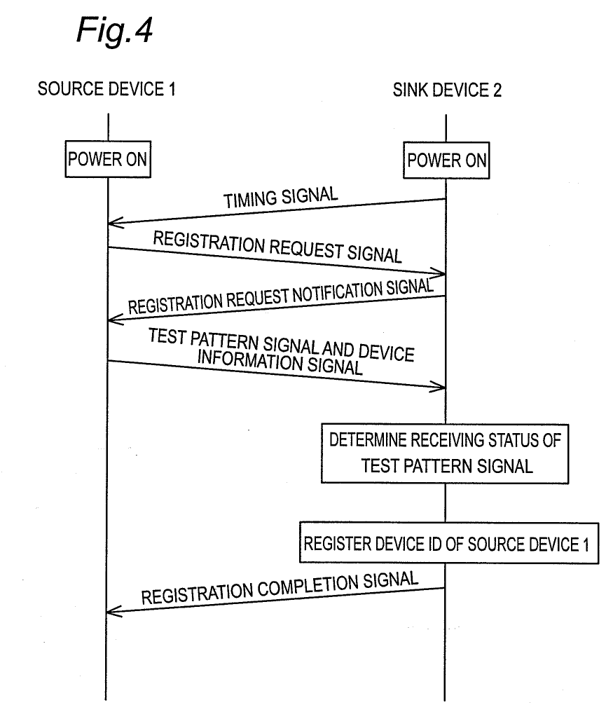

FIG. 4 is a sequence diagram showing a registration process performed by a wireless communication system according to a second embodiment of the present invention. The process from the timing when the power of the source device 1 and the sink device 2 are turned on to the timing when the sink device 2 transmits the registration request notification signal to the source device 1 is similar to that performed by the wireless communication system according to the first embodiment, and will not be described.

Referring to FIG. 4, first of all, in response to the registration request notification signal, the source device 1 transmits the test pattern signal to the sink device 2 via the directional antenna 3B, and transmits the device information signal including the device ID of the source device 1 to the sink device 2 via the omni-directional antenna 3A.

Upon receiving the test pattern signal via the directional antenna 4B, the sink device 2 determines a receiving status of the test pattern signal by operation of the controller 20. For example, the receiving status is measured by measuring an S/N ratio, an error rate or the like of the test pattern signal, and whether or not the receiving status is good is determined by determining whether or not the measured value is better than a predetermined threshold value. When it is determined that the receiving status of the test pattern signal is good by the controller 20, the sink device 2 stores and registers the device ID of the source device 1 in the memory 21 of the sink device 2. When the controller 20 determines that the receiving status is not good, the process is completed.

After storing and registering the device ID of the source device 1 in the memory 21 of the sink device 2, the sink device 2 transmits the registration completion signal indicating completion of registration of the source device 1 in the sink device 2 to the source device 1.

As described above, in the wireless communication system according to the present embodiment, upon registering the source device 1 in the sink device 2, the source device 1 wirelessly transmits the predetermined test pattern signal to the sink device 2, and the sink device 2 wirelessly receives the test pattern signal and measures the value indicating the receiving status of the test pattern signal. When the value indicates a receiving status better than a receiving status indicated by the predetermined threshold value, the device ID of the source device 1 is registered in the sink device 2. Accordingly, the receiving status of the test pattern signal is automatically determined and the source device 1 is registered in the sink device 2, without forcing the user to input whether or not to register the source device 1 in the sink device 2 using the keyboard 24. Accordingly, it is possible to further lessen the user's burden at the time of an initial setting.

In the present embodiment, the test pattern signal includes the test video signal and the test audio signal. However, the present invention is not limited to this configuration. The test pattern signal may include the other signal such as a data signal that can be used for determining the receiving status.

### Third Embodiment

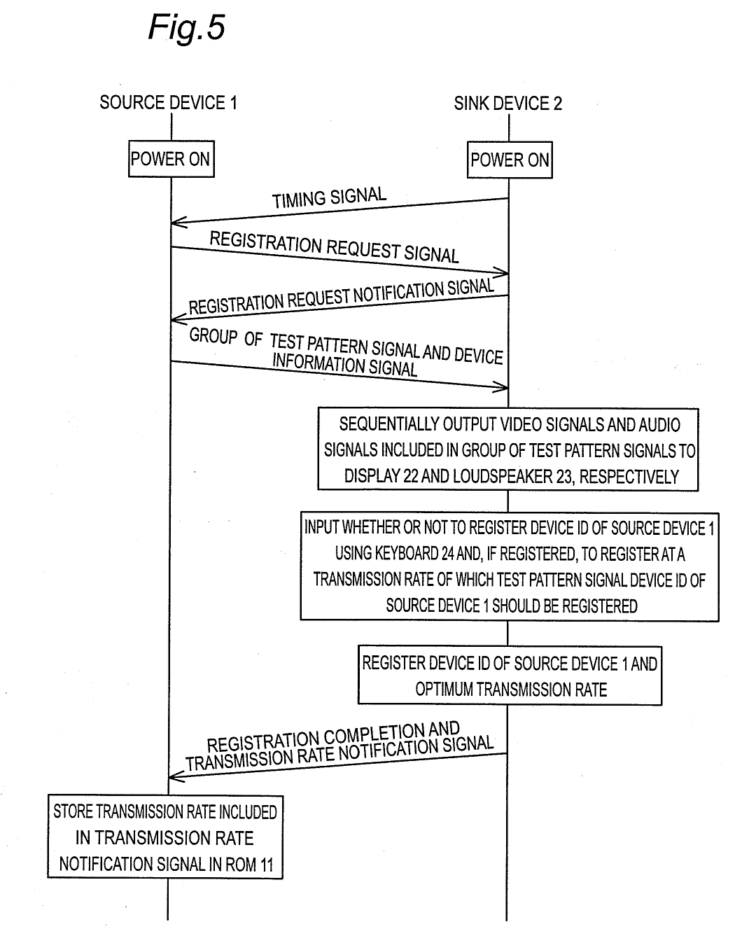

FIG. 5 is a sequence diagram showing a registration process performed by a wireless communication system according to a third embodiment of the present invention. The process from the timing when the power of the source device 1 and the sink device 2 are turned on to the timing when the sink device 2 transmits the registration request notification signal to the source device 1 is similar to that performed by the wireless communication system according to the first embodiment, and will not be described. In the third embodiment, control signals for registering the source device 1 in the sink device 2 include registration control signals including the timing signal, the registration request signal, the registration request notification signal and a registration completion and transmission rate notification signal, and the device information signal.

Referring to FIG. 5, first of all, in response to the registration request notification signal, the source device 1 transmits a group of test pattern signals each including video signals and audio signals, to the sink device 2 via the directional antenna 3B at transmission rates different from each other, respectively, and transmits the device information signal including the device ID of the source device 1 to the sink device 2 via the omni-directional antenna 3A.

Upon receiving the group of test pattern signals via the directional antenna 4B, the sink device 2 sequentially outputs the test video signal and the test audio signal of each of the transmission rates included in the group of test pattern signals to the display 22 and the loudspeaker 23. The sink device 2 displays on the display 22 a message for requesting to a user to select whether or not to register the device ID of the source device 1, and, if registered, select to register at a transmission rate of which test pattern signal the device ID of the source device 1 should be registered, and the like. The user determines receiving statuses by sequentially viewing and listening to the images and the voices outputted to the display 22 and the loudspeaker 23, respectively, and selects whether or not to register the source device 1 in the sink device 2, and, if registered, selects to register at a transmission rate of which test pattern signal the device ID of the source device 1 should be registered using the keyboard 24. When the user selects registration, the sink device 2 stores and registers the device ID of the source device 1 and the selected optimum transmission rate in the memory 21 of the sink device 2. On the other hand, when the user does not select registration, the process is completed.

After storing and registering the device ID of the source device 1 in the memory 21 of the sink device 2, the sink device 2 transmits the registration completion and transmission rate notification signal indicating that the registration of the source device 1 in the sink device 2 has been completed and notifying the source device 1 of the optimum transmission rate, to the source device 1. The source device 1 stores the transmission rate included in the transmission rate notification signal in the memory 11 of the source device 1, and uses the transmission rate stored in the memory 11, when the source device transmits the video signal and the audio signal read-out from the DVD player 12 to the sink device 2.

As described above, in the wireless communication system according to the present embodiment, upon registering the source device 1 in the sink device 2, the source device 1 wirelessly transmits the plurality of test pattern signals including the predetermined test video signals to the sink device 2 at the transmission rates different from each other, respectively, and the sink device 2 outputs and displays the test video signals included in the test pattern signals transmitted at the transmission rates different from each other, respectively, and a request to select whether or not to register the source device 1 in the sink device 2, to and on the display 22. When it is selected to register the source device 1 in the sink device 2 using the keyboard 24, the sink device 2 registers the device ID of the source device 1. Accordingly, the sink device 2 can receive and output a high quality video signal and a high quality audio signal.

### Fourth Embodiment

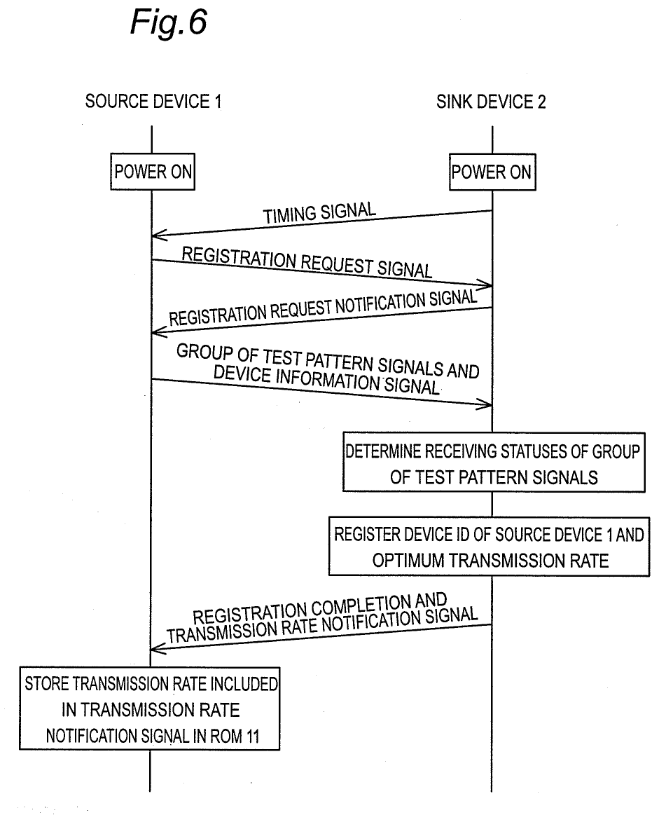

FIG. 6 is a sequence diagram showing a registration process performed by a wireless communication system according to a fourth embodiment of the present invention. The process from the timing when the power of the source device 1 and the sink device 2 are turned on to the timing when the sink device 2 transmits the registration request notification signal to the source device 1 is similar to that performed by the wireless communication system according to the first embodiment, and will not be described. In the fourth embodiment, control signals for registering the source device 1 in the sink device 2 include control signals including the timing signal, the registration request signal, the registration request notification signal and the registration completion and transmission rate notification signal, and the device information signal.

Referring to FIG. 6, first of all, in response to the registration request notification signal, the source device 1 transmits the group of the test pattern signals each including video signals and audio signals, to the sink device 2 via the directional antenna 3B at transmission rates different from each other, respectively, and transmits the device information signal including the device ID of the source device 1 to the sink device 2 via the omni-directional antenna 3A.

Upon receiving the group of test pattern signals via the directional antenna 4B, the sink device 2 determines a test pattern signal transmitted at which transmission rate indicates a best receiving status among the group of test pattern signals by operation of the controller 20. For example, the receiving statuses of the respective test pattern signals are determined by comparing S/N ratios, error rates or the like of the respective test pattern signals with each other. The sink device 2 stores and registers the device ID of the source device 1 and the transmission rate of the test pattern signal having the best receiving status in the memory 21 of the sink device 2, by operation of the controller 20.

After storing and registering the device ID of the source device 1 in the memory 21 of the sink device 2, the sink device 2 transmits the registration completion and transmission rate notification signal indicating that the registration of the source device 1 in the sink device 2 has been completed and notifying the source device 1 of the registered transmission rate to the source device 1. The source device 1 stores the transmission rate included in the transmission rate notification signal in the memory 11 of the source device 1, and uses the transmission rate stored in the memory 11 when the source device transmits the video signal and the audio signal read-out from the DVD player 12 to the sink device 2.

As described above, in the wireless communication system according to the present embodiment, upon registering the source device 1 in the sink device 2, the source device 1 wirelessly transmits the plurality of test pattern signals to the sink device 2 at the transmission rates different from each other, respectively, and the sink device 2 measures values indicating the receiving statuses of the test pattern signals, respectively, and registers the transmission rate corresponding to the test pattern signal having the best value and the device ID of the source device 1, so that the transmission rate corresponding to the test pattern signal having the best value corresponds to the device ID of the source device 1. Accordingly, the receiving statuses of the test pattern signals are automatically determined and the source device 1 is registered in the sink device 2, without forcing the user to input whether or not to register the source device 1 in the sink device 2 using the keyboard 24. Accordingly, it is possible to further lessen the user's burden at the time of the initial setting.

### Fifth Embodiment

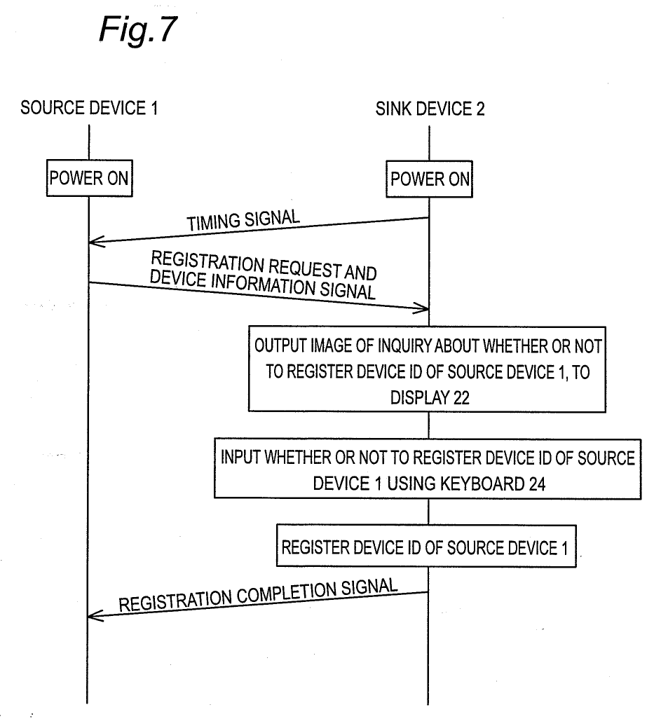

FIG. 7 is a sequence diagram showing a registration process performed by a wireless communication system according to a fifth embodiment of the present invention. The process from the timing when the power of the source device 1 and the sink device 2 are turned on to the timing when the sink device 2 transmits the timing signal to the source device 1 is similar to that performed by the wireless communication system according to the first embodiment, and will not be described. In the fifth embodiment, control signals for registering the source device 1 in the sink device 2 include registration control signals including the timing signal and the registration completion signal, and a registration request and device information signal.

Referring to FIG. 7, first of all, in response to the timing signal, the source device 1 transmits the registration request and device information signal for a request to register the source device 1 in the sink device 2 and for notifying the sink device 2 of a device ID of the source device 1, to the sink device 2 via the omni-directional antenna 3A. Upon receiving the registration request and device information signal via the omni-directional antenna 4A, the sink device 2 notifies a user of the request of registration, and outputs and displays a predetermined image or the like of an inquiry to the user about whether or not to register the device ID of the source device 1 in the sink device 2 to and on the display 22. The user selects whether or not to register the source device 1 in the sink device 2 using the keyboard 24. When the user selects registration, the sink device 2 stores and registers the device ID of the source device 1 in the memory 21 of the sink device 21. On the other hand, when the user does not select registration, the process is completed. It is configured so that that the sink device 2 outputs and displays the predetermined image or the like for notifying the user of the request of registration. However, the sink device 2 is not required to output the predetermined image or the like, when the request of registration is not accepted according to a user setting.

After storing and registering the device ID of the source device 1 in the memory 21 of the sink device 2, the sink device 2 transmits the registration completion signal indicating that the registration of the source device 1 in the sink device 2 has been completed to the source device 1.

As described above, in the wireless communication system according to the present embodiment, upon registering the source device 1 in the sink device 2, the sink device 2 wirelessly receives the control signal including the device ID from the source device 1, outputs and displays the request to select whether or not to register the source device 1 in the sink device 2 to and on the display 22. When it is selected to register the source device 1 in the sink device 2 using the keyboard 24, the sink device 2 registers the device ID of the source device 1. Accordingly, the source device 1 is registered in the sink device 2 without transmitting any test pattern signals. Accordingly, it is possible to shorten time required for the registration process and to simplify the initial setting.

In addition, when the directional antennas 3B and 4B are employed for the registration process, it is required to restrict communication areas of the respective directional antennas 3B and 4B, in order to prevent registration of an illegal device. Accordingly, there is such a problem that installation locations of the source device 1 and the sink device 2 are restricted. In the wireless communication system according to the present embodiment, only the omni-directional antennas 3A and 4A are employed for the registration process. Therefore, as compared with the registration methods according to the first to fourth embodiments, the communication areas of the directional antennas 3B and 4B for wirelessly transmitting the video signal and the audio signal can set to be wider, and it is possible to relax the restrictions on the installation locations of the source device 1 and the sink device 2.

Upon receiving the registration request and device information signal, the sink device 2 outputs the predetermined image. However, the present invention is not limited to this operation. Alternatively, the sink device may convert the data included in the registration request and device information signal into an image, a voice, an indicator or the like based on the data included in the registration request and device information signal, and may output the image, the voice, the indicator or the like to the display 22 or the loudspeaker 23.

### Sixth Embodiment

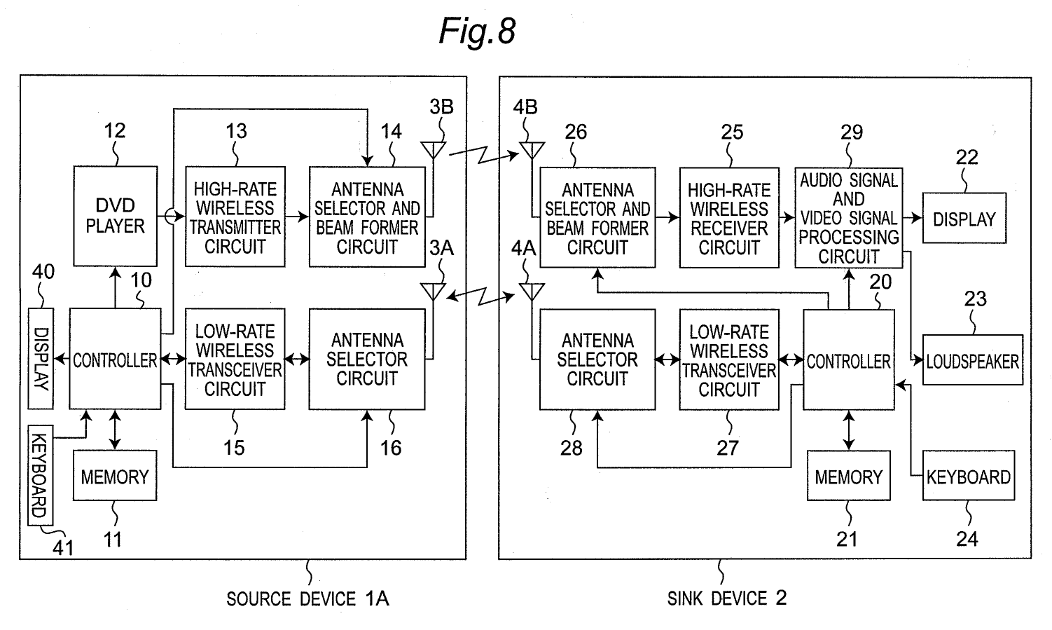

FIG. 8 is a block diagram showing a configuration of a wireless communication system according to a sixth embodiment of the present invention. Referring to FIG. 8, a source device 1A is different from the source device 1 according to the first embodiment of FIG. 1 in that the source device 1A further includes a display 40 and a keyboard 41. The other components of the device 1A are similar to those of the source device 1 according to the first embodiment of FIG. 1, and the constituent elements denoted by the reference symbols that are the same as those of FIG. 1 will not be described in detail. In the sixth embodiment, control signals for registering the source device 1A in the sink device 2 include registration control signals including the timing signal, the registration request signal, the registration request notification signal and the registration completion signal, and a registration setting and device information signal.

Referring to FIG. 8, the display 40 outputs an image or the like of an inquiry to a user about whether or not to register the source device 1 in the sink device 2 under control of the controller 10. The user inputs whether or not to register the source device 1 in the sink device 2 using the keyboard 41.

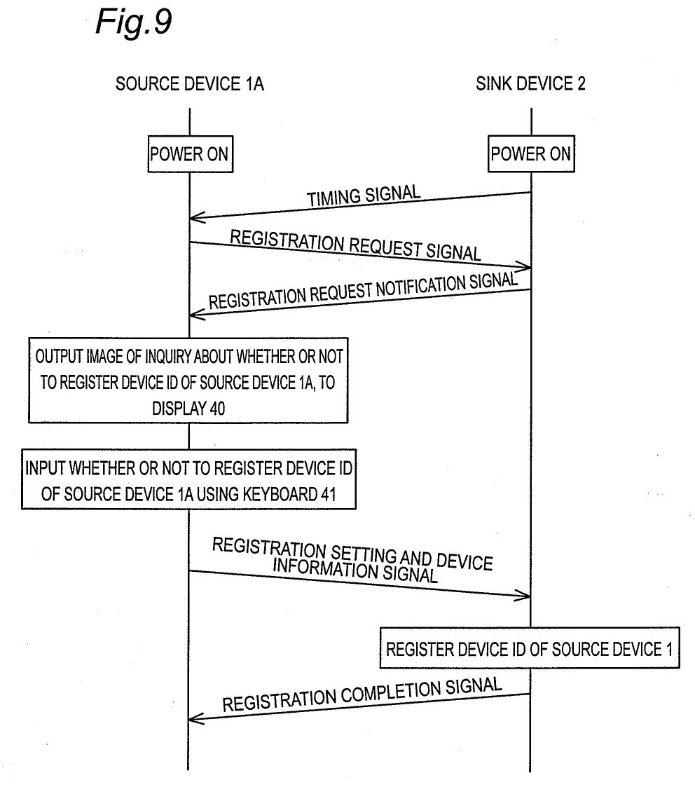

FIG. 9 is a sequence diagram showing a registration process performed by the wireless communication system according to the sixth embodiment of the present invention. The process from the timing when the power of the source device 1A and the sink device 2 are turned on to the timing when the sink device 2 transmits the registration request notification signal to the source device 1A is similar to that performed by the wireless communication system according to the first embodiment, and will not be described.

Referring to FIG. 9, first of all, upon receiving the registration request notification signal, the source device 1 outputs a predetermined image or the like of an inquiry to a user about whether or not to register a device ID of the source device 1A in the sink device 2 to the display 40. The user selects whether or not to register the source device 1A in the sink device 2 using the keyboard 24. When the user selects registration, the source device 1A transmits the registration setting and device information signal for confirming registration of the source device 1A in the sink device 2 and for notifying the sink device 2 of the device ID of the source device 1A to the sink device 2 via the omni-directional antenna 3A. On the other hand, when the user does not select registration, the process is completed. Upon receiving the registration setting and device information signal via the omni-directional antenna 4A, the sink device 2 stores and registers the device ID of the source device 1A in the memory 21 of the sink device 2.

After storing and registering the device ID of the source device 1A in the memory 21 of the sink device 2, the sink device 2 transmits the registration completion signal indicating completion of the registration of the source device 1 in the sink device 2 to the source device 1A via the omni-directional antenna 4A.

As described above, in the wireless communication system according to the present embodiment, the source device 1A displays the request to select whether or not to register the source device 1A in the sink device 2 on the display 40. When it is selected to register the source device 1A in the sink device 2 using the keyboard 41, the source device 1A wirelessly transmits the device ID of the source device 1A to the sink device 2. Accordingly, it is possible to display and input at the source device 2 whether or not to register the source device 1A in the sink device 2.

In the first to sixth embodiments, directivities of the directional antennas 3B and 4B may be either fixed or variable. Even when the directivities are variable, the directivities may be fixed to predetermined directions at the time of the initial setting, respectively. In addition, a frequency band of the omni-directional antennas 3A and 4A, and a frequency band of the directional antennas 3B and 4B may be the same as each other or different from each other.

In addition, in the first to sixth embodiments, the source device and the sink device hold one-to-one wireless communication. However, the present invention is not limited to this configuration. For example, a star network configuration may be adopted, in which a plurality of source devices wirelessly communicates with one sink device.

Further, in the first to sixth embodiments, instead of the keyboard 24 or 41, the other input means such as a remote controller may be employed.

Still further, in the first to sixth embodiments, the user inputs information using the keyboard 24 or 41. However, it may be automatically decided to register the source device 1 or 1A in the sink device 2, after a lapse of a predetermined time after the request to select whether or not to register the source device 1 or 1A in the sink device 2.

In addition, in the first to third embodiments, the sink device 2 outputs the test video signal and the test audio signal to the display 22 and the loudspeaker 23, respectively. However, the present invention is not limited to this configuration. Alternatively, test results may be outputted, instead of or in addition to the test video signal and the test audio signal. Further, the test video signal, the test audio signal, and the test results may not be outputted.

### INDUSTRIAL APPLICABILITY

In the source device, the sink device, the wireless communication system, and the registration method therefor according to the present invention, the source device wirelessly transmits the control signal including the identification information on the source device to the sink device, and the sink device wirelessly receives the control signal including the identification information on the source device and registers the identification information. When the sink device wirelessly receives a video signal from the source device, the sink device displays the video signal from the source device only when identification information corresponding to the source device is registered in the sink device. Accordingly, in the wireless communication system in which the video signal is wirelessly transmitted between the source device and the sink device, it is possible to lessen user's burden at the time of the initial setting for the registration of the source device in the sink device, and to ensure excellent confidentiality.

The source device, the sink device, the wireless communication system, and the registration method according to the present invention are applicable to an audiovisual system or the like for wirelessly transmitting an uncompressed video signal and the like reproduced and outputted by the source device such as a DVD player to a sink device such as a television receiver.

1-26. (canceled)

27. A source device for use in a wireless communication system, the wireless communication system comprising the source device including a wireless transmitter for wirelessly transmitting a video signal, and a sink device including a wireless receiver for receiving the wirelessly transmitted video signal, the source device comprising:
a first storage unit for storing identification information on the source device; and
a first wireless transceiver for wirelessly transmitting a control signal including the identification information read-out from the first storage unit to the sink device, and for wirelessly receiving a registration control signal for registering the source device in the sink device, from the sink device,
wherein, the wireless transmitter wirelessly transmits a plurality of predetermined test pattern signals to the sink device at transmission rates different from each other, respectively, and the first wireless transceiver wirelessly transmits the control signal including the read-out identification information to the sink device, and
wherein the test pattern signals include predetermined test video signals, respectively.

28. A source device for use in a wireless communication system, the wireless communication system comprising the source device including a wireless transmitter for wirelessly transmitting a video signal, and a sink device including a wireless receiver for receiving the wirelessly transmitted video signal, the source device comprising:
a first storage unit for storing identification information on the source device;
a first wireless transceiver for wirelessly transmitting a control signal including the identification information read-out from the first storage unit to the sink device, and for wirelessly receiving a registration control signal for registering the source device in the sink device, from the sink device;
a first display unit;
a first input unit; and
a first controller,
wherein the first controller displays on the first display unit a request to select whether or not to register the source device in the sink device, and
wherein, when it is selected to register the source device in the sink device using the first input unit, the first controller controls the first wireless transceiver to wirelessly transmit the control signal including the read-out identification information to the sink device.

29. A sink device for use in a wireless communication system, the wireless communication system comprising a source device including a wireless transmitter for wirelessly transmitting a video signal, and the sink device including a wireless receiver for receiving the wirelessly transmitted video signal, the sink device comprising:
a second wireless transceiver for wirelessly receiving a control signal including identification information on the source device from the source device, and for wirelessly transmitting a registration control signal for registering the source device in the sink device to the source device;
a second storage unit for storing and registering the wirelessly received identification information;
a second display unit for displaying the video signal from the source device; and
a second controller for controlling the second display unit to display the video signal from the source device thereon, when the wireless receiver wirelessly receives the video signal from the source device, and only when identification information corresponding to the source device is registered in the second storage unit,
wherein, the wireless receiver wirelessly receives a predetermined test pattern signal from the source device, and the second wireless transceiver wirelessly receives the control signal including the identification information from the source device, and
wherein the second controller measures a value indicating a receiving status of the test pattern signal, and controls the second storage unit to store and register the wirelessly received identification information therein when the value indicates a receiving status better than a receiving status indicated by a predetermined threshold value.

30. A sink device for use in a wireless communication system, the wireless communication system comprising a source device including a wireless transmitter for wirelessly transmitting a video signal, and the sink device including a wireless receiver for receiving the wirelessly transmitted video signal, the sink device comprising:
a second wireless transceiver for wirelessly receiving a control signal including identification information on the source device from the source device, and for wirelessly transmitting a registration control signal for registering the source device in the sink device to the source device;
a second storage unit for storing and registering the wirelessly received identification information;
a second display unit for displaying the video signal from the source device;
a second controller for controlling the second display unit to display the video signal from the source device thereon, when the wireless receiver wirelessly receives the video signal from the source device, and only when identification information corresponding to the source device is registered in the second storage unit; and
a second input unit,
wherein, the wireless receiver wirelessly receives a test pattern signal including a predetermined test video signal, and the second wireless transceiver wirelessly receives the control signal including the identification information from the source device, and
wherein the second controller displays on the second display unit the test video signal and a request to select whether or not to register the source device in the sink device, and controls the second storage unit to store and register the wirelessly received identification information therein when it is selected to register the source device in the sink device using the second input unit.

31. A sink device for use in a wireless communication system, the wireless communication system comprising a source device including a wireless transmitter for wirelessly transmitting a video signal, and the sink device including a wireless receiver for receiving the wirelessly transmitted video signal, the sink device comprising:
a second wireless transceiver for wirelessly receiving a control signal including identification information on the source device from the source device, and for wirelessly transmitting a registration control signal for registering the source device in the sink device to the source device;
a second storage unit for storing and registering the wirelessly received identification information;
a second display unit for displaying the video signal from the source device;
a second controller for controlling the second display unit to display the video signal from the source device thereon, when the wireless receiver wirelessly receives the video signal from the source device, and only when identification information corresponding to the source device is registered in the second storage unit; and
a second input unit,
wherein the wireless receiver wirelessly receives a plurality of test pattern signals including predetermined test video signals and wirelessly transmitted at transmission rates different from each other, respectively, and the second wireless transceiver wirelessly receives the control signal including the identification information from the source device, and
wherein the second controller displays on the second display unit (a) the test video signals for the respective transmission rates different from each other and (b) a request to select whether or not to register the source device in the sink device, and controls the second storage unit to store and register the wirelessly received identification information therein when it is selected to register the source device in the sink device using the second input unit.

32. A sink device for use in a wireless communication system, the wireless communication system comprising a source device including a wireless transmitter for wirelessly transmitting a video signal, and the sink device including a wireless receiver for receiving the wirelessly transmitted video signal, the sink device comprising:
a second wireless transceiver for wirelessly receiving a control signal including identification information on the source device from the source device, and for wirelessly transmitting a registration control signal for registering the source device in the sink device to the source device;
a second storage unit for storing and registering the wirelessly received identification information;
a second display unit for displaying the video signal from the source device;
a second controller for controlling the second display unit to display the video signal from the source device thereon, when the wireless receiver wirelessly receives the video signal from the source device, and only when identification information corresponding to the source device is registered in the second storage unit; and
a second input unit,
wherein the second wireless transceiver wirelessly receives the control signal including the identification information from the source device, and
wherein the second controller displays on the second display unit a request to select whether or not to register the source device in the sink device, and controls the second storage unit to store and register the wirelessly received identification information therein when it is selected to register the source device in the sink device using the second input unit.

33. The source device as claimed in claim 27,
wherein the wireless transmitter comprises a directional antenna, and
wherein the first wireless transceiver comprises an omni-directional antenna.

34. The source device as claimed in claim 28,
wherein the wireless transmitter comprises a directional antenna, and
wherein the first wireless transceiver comprises an omni-directional antenna.

35. The source device as claimed in claim 27,
wherein a transmission rate of the wireless transmitter for wireless transmission is larger than that of the first wireless transceiver for wireless transmission and receiving.

36. The source device as claimed in claim 28,
wherein a transmission rate of the wireless transmitter for wireless transmission is larger than that of the first wireless transceiver for wireless transmission and receiving.

37. The sink device as claimed in claim 29,
wherein the wireless receiver comprises a directional antenna, and
wherein the second wireless transceiver comprises an omni-directional antenna.

38. The sink device as claimed in claim 30,
wherein the wireless receiver comprises a directional antenna, and
wherein the second wireless transceiver comprises an omni-directional antenna.

39. The sink device as claimed in claim 31,
wherein the wireless receiver comprises a directional antenna, and
wherein the second wireless transceiver comprises an omni-directional antenna.

40. The sink device as claimed in claim 32,
wherein the wireless receiver comprises a directional antenna, and
wherein the second wireless transceiver comprises an omni-directional antenna.

41. The sink device as claimed in claim 29,
wherein a transmission rate of the wireless receiver for wireless receiving is larger than that of the second wireless transceiver for wireless transmission and receiving.

42. The sink device as claimed in claim 30,
wherein a transmission rate of the wireless receiver for wireless receiving is larger than that of the second wireless transceiver for wireless transmission and receiving.

43. The sink device as claimed in claim 31,
wherein a transmission rate of the wireless receiver for wireless receiving is larger than that of the second wireless transceiver for wireless transmission and receiving.

44. The sink device as claimed in claim 32,
wherein a transmission rate of the wireless receiver for wireless receiving is larger than that of the second wireless transceiver for wireless transmission and receiving.
